(19) United States
(12) Patent Application Publication
(10) Pub. No.: US 2004/0264467 A1
(43) Pub. Date: Dec. 30, 2004

(54) Method and apparatus for data packet switching

(75) Inventors: Andreas Foglar, Munchen (DE); Gunnar Hagen, Unterhaching (DE)

Correspondence Address: Dicke, Billig & Czaja, PLLC, Fifth Street Towers, Suite 2250, 100 South Fifth Street, Minneapolis, MN, 55402, US

(73) Assignee: Infineon Technologies AG

(21) Appl. No.: 10/871,762

(22) Filed: Jun. 17, 2004

(30) Foreign Application Priority Data
Jun. 27, 2003 (DE) 103 29 056.7

(51) Int. Cl. H04L 12/28; H04L 12/56

(52) U.S. Cl. 370/392; 370/408

(57) ABSTRACT

Several sub-switching units are provided in a switching apparatus for routing data packets, which according to the transmission protocol used have protocol packet data in addition to utilizable data in each case. In order to be able to centrally perform the processing work in connection with routing the data packets in a few and particularly in a single sub-switching unit, switching packet data are produced in at least one first sub-switching unit and assigned to the data packets. The switching packet data are analyzed in another second sub-switching unit and used for routing or processing the data packets. In this way, tasks can be centralized on a few and particularly on a single sub-switching unit.

### CROSS-REFERENCE TO RELATED APPLICATIONS

This Utility Patent Application claims priority to German Patent Application No. DE 103 29 056.7, filed on Jun. 27, 2003, which is incorporated herein by reference.

### BACKGROUND

The present invention relates to a method as well as an apparatus for implementing the method for routing data packets in a switching device, whereby the data packets have protocol packet data corresponding to the transmission protocol used.

In the case of packet-based data transmission the utilizable data are transmitted in data packets, which additionally contain protocol packet data. These protocol packet data are produced according to the transmission protocol used in each case and added to the utilizable data. The protocol packet data, for example, can be the source of the data, destination of the data, type of the data transmitted, identifiers of the actual connection or check data for verifying transmission errors. For example, the protocol packet data can be used for routing the data so that the data packets reach the required destination. Additionally, the protocol packet data can be used for other functions that are not directly connected with the routing of data packets. For example, packet data can be used for monitoring the bandwidth, combining or segmenting various data packets or producing a constant bit rate.

The protocol packet data may be produced on the basis of a hierarchical layer model, such as the ISO OSI model and added to the utilizable data. Furthermore, the protocol packet data are mostly added before or after the utilizable data in the form of headers or trailers.

Thus, for routing data packets several processing rules must be complied with and implemented. This is usually carried out in various components of the processor unit. Therefore, in the event of a change in the processing rules the corresponding areas and/or components in the switching apparatus must be replaced or at least modified. This may be necessary, for example, if the protocols used for the transmission, or if the processing rules implemented, change. Replacement and/or modification of components in the switching apparatus, however, is disadvantageously associated with costs.

### SUMMARY

One embodiment of the present invention creates a method and/or an apparatus of the type initially specified, in the case of which adjustment to changed requirements during the data communication can be carried out at minimum cost.

In one embodiment of the invention, the switching apparatus has several sub-switching units, which are interconnected. Furthermore, switching packet data are produced by at least one first sub-switching unit and added to the respective data packets. These switching packet data are transmitted with the corresponding packet to at least one second sub-switching unit and read there. In the at least one second sub-switching unit, processing rules are implemented or the data packets are switched and/or processed depending on the switching packet data.

In this way, the execution of processing rules within the switching apparatus can be implemented specifically in certain sub-switching units and particularly in only a single sub-switching unit. In the event of a change in the processing rules only the sub-switching unit concerned needs to be modified or replaced.

In one embodiment the switching packet data are inserted between layer 2 and layer 3 in the case of the ISO OSI layer model.

A cost advantage can be achieved in centrally using one data processing device with high performance than in using several data processing devices of lower performance.

Although the additional switching packet data used slightly increases the data ensuing within the switching apparatus, on the other hand they offer advantages as regards the efficiency of the data packet switching and/or processing.

In one embodiment, the switching packet data added within the switching apparatus are again removed from the data packets, as soon as these leave the switching apparatus again. Therefore, the switching packet data do not become visible to the outside, so that the switching apparatus can be operated in the usual environment without modification.

The switching apparatus can, for example, have a tree structure, in which the data are transmitted between a trunk line and several branch lines, whereby aggregation toward the trunk line and desegregation toward the branch lines results. In this case, it can also be arranged that switching between two different branch lines is not possible, but that the data packets are transmitted exclusively from the trunk line to a branch line and/or vice-versa from a branch line to the trunk line.

In one embodiment, a main sub-switching unit, which is connected to the trunk line, is provided. The branch lines in turn can be connected to at least one further sub-switching unit, which is again connected to the main switching unit. Between the sub-switching units, which are directly connected to the branch lines, and the main switching unit, further levels of sub-switching units can be interspersed. A main switching unit is also used as a priority for executing processing rules when routing and/or processing data packets. The other sub-switching units therefore can be provided with less processing capacity, so that the costs are reduced in these cases. With regard to the other sub-switching units, which are to be kept as simple and economic as possible, it can therefore be arranged that only absolutely essential switching packet data are added. These can be, for example, information about the line, via which the data packet has arrived.

Processing rules, which were executed in the prior art for a particular sub-switching unit, in accordance with one embodiment of the invention can be implemented later in another sub-switching unit, where the transactions are handled collectively as a result of adding the switching packet data on the transmission path within the switching apparatus. The information necessary for this can be added in the data packet to the switching packet data en route, before the data packet has arrived at the sub-switching unit executing the processing rules.

If, vice-versa, the data packet initially passes a first sub-switching unit, where the processing rules are to be executed collectively, and then arrive at a second sub-switching unit, in which according to the prior art the implementation of the processing rules would have been necessary, the execution of the processing rule in the second sub-switching unit can already be prepared and/or partially implemented in the first sub-switching unit. Results of this transaction can be added to the data packet in the form of switching packet data en route, so that the processing work in the second sub-switching unit can be reduced.

The processing rules can, for example, be the identification of a transmission path within the switching apparatus depending on the protocol packet data. The first sub-switching unit would analyze the protocol packet data, identify the transmission path and send data in the form of switching packet data to at least one second sub-switching unit. There, depending on these data the data packet is forwarded on so that the second sub-switching unit does not need to analyze the protocol packet data.

In one embodiment, the present invention is used for DSL (Digital Subscriber Line) data transmission. As a result, multiple services can also be transmitted. With such DSL, data transmission multiplexers are often used as switching devices, in which a trunk card as a main sub-switching unit is used together with line cards for connecting to branch lines. In order to create a system that is as flexible as possible, as much processing as possible is performed in the trunk card. In this way, the processing work in the line cards can be kept to a minimum, so that if requirements for the routing of data packets change the line cards can be used for as long a time as possible in unmodified form. Since the line cards are present in substantially higher numbers than the trunk cards, a cost advantage also results. For example, modifications as a rule initially will only concern the trunk card so that the line cards can also be used together with other trunk cards.

### BRIEF DESCRIPTION OF THE DRAWINGS

The accompanying drawing is included to provide a further understanding of the present invention and is incorporated in and constitute a part of this specification. The drawing illustrates the embodiments of the present invention and together with the description serve to explain the principles of the invention. Other embodiments of the present invention and many of the intended advantages of the present invention will be readily appreciated, as they become better understood by reference to the following detailed description. The elements of the drawing are not necessarily to scale relative to each other. Like reference numerals designate corresponding similar parts.

FIG. 1 illustrates a schematic circuit diagram of a switching apparatus for routing data packets according to the DSL standard.

### DETAILED DESCRIPTION

In the following Detailed Description, reference is made to the accompanying drawing, which forms a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

The switching apparatus illustrated in FIG. I possesses a tree structure with a trunk line 7 and several branch lines 8. The data traffic takes place between the trunk line 7 and the branch lines 8. In one embodiment, the data traffic takes place exclusively between the trunk line 7 and the branch lines 8. The trunk line 7 is connected to a trunk card 1 and/or main sub-switching unit 1, via which the data traffic flows. The branch lines 8 are connected in groups to one of several line cards 4. The line cards 4 are in turn connected by means of intermediate lines 9 with the trunk card 1. The trunk card 1 has a multiplexer 2, which is connected to the intermediate lines 9. Furthermore, a processing device 3 is provided in the trunk card 1, which has means for processing and/or analyzing the data packets.

Each of the line cards 4 has a first multiplexer 5, the collective line of which is connected to a central line 9. The branch lines of the first multiplexers 5 are connected to collective lines by several second multiplexers 6 on each line card 4 respectively. The branch lines of the second multiplexers 6 are finally connected to the branch lines 8.

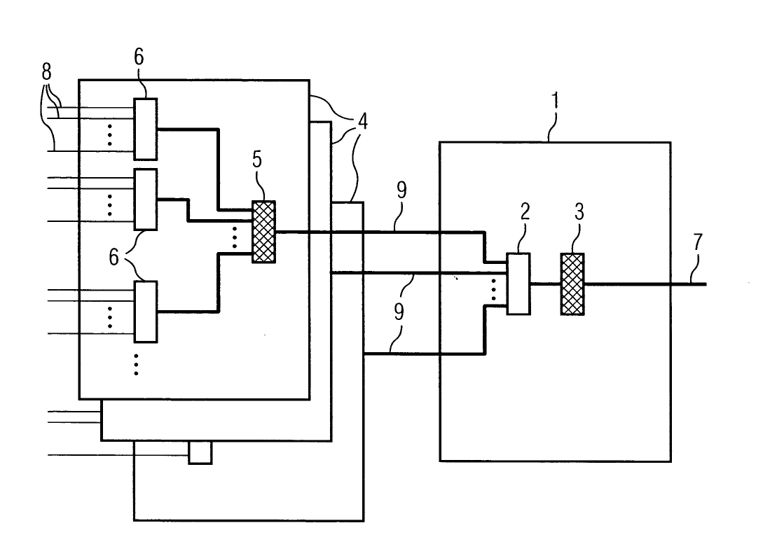

The switching apparatus illustrated in FIG. 1 serves to transfer data packets, which are transmitted according to various transmission protocols. The data packets therefore can have various formats according to the transmission protocol used in each case and thus protocol packet data, which contain information necessary for the transmission.

Within the switching apparatus further auxiliary functions are to be additionally executed for routing the data packets. These comprise, for example, monitoring the bandwidth in particular for individual links, a check as to whether a certain connection is generally valid, recording charges, producing a constant bit rate or segmenting individual data packets into smaller units or combining several data packets into one data packet.

Processing work also arises in connection with routing data packets, since the protocol packet data must be analyzed in order to define the transmission paths within the switching apparatus. At the same time, the processing work arising within the switching apparatus is to be executed to the greatest possible extent by the trunk card 1. In this way, the line cards 4 present in large numbers can be realized more simply and more economically.

For this reason, the trunk card 1 and the line cards 4 are arranged in such a manner that additionally to the protocol packet data within the data packets they can produce switching packet data and add these to the data packets, whereby the switching packet data are only used within the switching apparatus and are removed again from the data packet, as soon as this leaves the switching apparatus.

With regard to data packets, which arrive via one of the branch lines 8, processing rules are executed in the corresponding line card 4 only so far as they absolutely must be executed in the line card 4. All other functions are given over to the trunk card 1, wherefore the line card 4 prepares corresponding switching packet data and adds these to the data packet en route to the trunk card 1. As soon as the data packets have arrived in the trunk card 1, the switching packet data are analyzed there and the necessary transactions are executed. In this case, for example, the switching packet data can contain information as to which branch line 8 the corresponding data packet has arrived on. The switching packet data added over and above to the line card 4 relates in particular to information, which is exclusively received by the line card 4 and which is not known to trunk card 1. The data packets arrive in this way from the branch lines 8 as far as the trunk card 1 together with all information that is necessary for executing the necessary transactions so that these transactions can also be performed by the trunk card 1.

If, vice-versa, data arrive via the trunk line 7, then the processing rules are implemented to the greatest possible extent directly in the trunk card 1. Actions that take place in the line cards 4, such as the distribution of the data packets to the individual branch lines 8, are prepared in the trunk card 1, if possible. For example, the protocol packet data of the data packets can be analyzed in trunk card 1. As a result of this evaluation switching packet data can be added to the data packets en route to the corresponding line card 4. As a result, the line card 4 can perform the necessary switching activities with less work.

In one embodiment, the protocol packet data of the data packets correspond to a hierarchical layer model according to the ISO OSI standard. The switching packet data in this case are inserted between the protocol layers 2 and 3 as an additional layer.

In one embodiment, the switching packet data can have references that are so limited they can be mapped entirely on one character set of 32 bits. Furthermore, the switching packet data can relate to a set of processing rules, appear particularly relevant for the node points of a tree structure aligned to the aggregation/desegregation of PDUs (for example, multicast group, round robin out of local group). Likewise, the switching packet data can relate to a set of processing rules, that are so structured that a subset of these in turn can be combined in such a way to form a system pipeline, so that only a minimum of resource-intensive processing rules need to be implemented on a line card 4. For example, it can be arranged that no AAL5-reassembly takes place on the line-card 4. Instead, fault encapsulation of the AAL5 ATM-cell stream and forwarding for reassembly on the trunk card 1 are carried out. Equally, the switching packet data can designate a packet-specific context, for example, a time stamp or line number unique within the system.

Furthermore, the protocol of the switching packet data used can be so arranged that an individual Ether type value for identifying the protocol from layer 2 is provided. In addition, the structure of the switching packet data can be interpreted depending on direction, whereby the direction results implicitly evident via the destination line. Likewise part of the structure lying on a fixed address for the switching packet data, which may for example have 32 bits, can be understood directly as start address of an assigned processing thread, whereby another part can be interpreted if necessary as a parameter.

The parameters within the switching packet data can also represent a system path identifier that explicitly refers to a processing pipe, which extends over the entire system. Equally, the parameters can represent a reference to a local group, as for example various ports of a multicast group.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method for routing data packets in a switching apparatus that has several sub-switching units, wherein the data packets contain utilizable data and protocol packet data that are assigned to the utilizable data according to a transmission protocol relevant for the transmission of the respective data packet, the method comprising:
producing switching packet data in at least one first sub-switching unit and adding the switching packet data to the data packets;
transmitting the data packets with switching packet data to at least one second sub-switching unit different from the first sub-switching unit; and
reading the switching packet data and processing the data packet dependent on this.

2. The method of claim 1, characterized in that the switching apparatus has a tree structure with a trunk line and several branch lines, wherein the trunk line is connected through branches to the branch lines.

3. The method of claim 2, characterized in that the data packets can be routed exclusively between the trunk line and the branch lines.

4. The method of claim 2, characterized in that the trunk line is connected to a main sub-switching unit, which is connected to further sub-switching units for connecting to the branch lines.

5. The method of claim 1, further including producing and adding the switching packet data for a data packet by the sub-switching unit via which the data packet arrives in the switching apparatus.

6. The method of claim 1, further including performing auxiliary functions other than the routing of data packets in the switching apparatus for handling the data packets, whereby the auxiliary functions are carried out exclusively in at least one particular processing sub-switching unit.

7. The method of claims 4, further including performing the auxiliary functions in the main sub-switching unit.

8. The method of claim 6, characterized in that the auxiliary functions are one or more of a group comprising monitoring the bandwidth, checking the validity of a connection, recording charges, producing a constant bit rate, segmenting, and combining data packets.

9. The method of claim 1, characterized in that the protocol packet data correspond to a hierarchical layer model and the switching packet data are inserted between two layers lying above one another.

10. The method of claim 1, characterized in that the switching apparatus is arranged in such a manner that it can route data packets of various data protocols.

11. The method of claim 1, characterized in that the switching apparatus is used for DSL data transmission.

12. A switching apparatus for routing data packets that have utilizable data and protocol packet data assigned to the utilizable data according to a transmission protocol relevant for the transmission of the respective data packet, the switching apparatus comprising:
at least one first sub-switching unit for producing switching packet data and adding switching packet data to the data packets;
at least one second sub-switching unit for receiving the data packets with switching packet data and for reading the switching packet data and processing the data packet depending on this.

13. The switching apparatus of claim 12, further including a tree structure with a trunk line and several branch lines, wherein the trunk line is connected through branches to the branch lines.

14. The switching apparatus of claim 13 configured such that the data packets can be routed exclusively between the trunk line and the branch lines.

15. The switching apparatus of claim 13, wherein the trunk line is connected to a main sub-switching unit, which is connected to further sub-switching units for connecting to the branch lines.

16. The switching apparatus of claim 12, wherein the switching packet data for a data packet are produced and added by the sub-switching unit via which the data packet arrives in the switching apparatus.

17. The switching apparatus of claim 12 wherein auxiliary functions other than the routing of data packets are performed in the switching apparatus for handling the data packets, and wherein the auxiliary functions are carried out exclusively in at least one particular processing sub-switching unit.

18. The switching apparatus of claim 16 wherein the auxiliary functions are performed in the main sub-switching unit.

19. The switching apparatus of claim 17 wherein the auxiliary functions are one or more of the group comprising monitoring the bandwidth, checking the validity of a connection, recording changes, producing a constant bit rate, segmenting, and combining data packets.

20. The switching apparatus of claim 12 wherein the protocol packet data correspond to a hierarchical layer model and the switching packet data are inserted between two layers lying above one another.

21. The switching apparatus of claim 12 configured in such a manner that it can route data packets of various data protocols.

22. The switching apparatus of claim 12 configured for use in DSL data transmission.
